(19) United States
(12) Patent Application Publication
(10) Pub. No.: US 2008/0093998 A1
(43) Pub. Date: Apr. 24, 2008

(54) LED AND CERAMIC LAMP

(75) Inventors: Frantz Dennery, Merinchal (FR); Alain Bricoune, Venice, FL (US)

Correspondence Address: GIFFORD, KRASS, SPRINKLE,ANDERSON & CITKOWSKI, P.C, PO BOX 7021, TROY, MI, 48007-7021, US

(73) Assignee: Led To Lite, LLC, Venice, FL (US)

(21) Appl. No.: 11/690,872

(22) Filed: Mar. 26, 2007

(30) Foreign Application Priority Data
Oct. 24, 2006 (FR) 0609311

(51) Int. Cl. H05B 41/16

(52) U.S. Cl. 315/246

(57) ABSTRACT

An LED lighting device for use in and powered through an incandescent light bulb alternating current socket is provided. The lighting device includes an LED light, a regulation circuit and a base. The regulation circuit converts an alternating current input to a direct current output. The base is adapted to fit within an incandescent light bulb alternating current socket. In addition to the LED light, regulation circuit and base, the invention can further include a heat sink that removes heat from the LED light, regulation circuit and combinations thereof. Preferably the heat sink is a ceramic. In addition, the regulation circuit can be a printed circuit that is printed directly onto the ceramic heat sink. The LED light, regulation circuit, base, and ceramic heat sink take the form of a lighting device that is exchangeable with an incandescent light bulb in traditional lighting fixtures.

### FIELD OF THE INVENTION

This invention relates generally to lighting devices and more particularly to a light emitting diode (LED) lighting device,

### BACKGROUND OF THE INVENTION

A light emitting diode (LED) is one type of semiconductor diode including a piece of semiconducting material, sometimes known as a chip, impregnated or doped with impurities to create a p-n junction. As with other diodes, an electrical current flows easily from the p-side, or anode, to the n-side, or cathode, but not in the reverse direction. Charge carriers (electrons and electron holes) flow into the junction from electrodes with different voltages. When an electron and an electron hole meet, the electron falls into a lower energy level, and releases energy in the form of a photon.

The wavelength of the light emitted from an LED depends on the band gap energy of the semiconducting material forming the p-n junction. Materials used for LEDs have a direct band gap with energies corresponding to near-infrared, visible or near-ultraviolet light.

In comparison to traditional incandescent light bulbs, LEDs are very energy efficient. For example, approximately 95% of the power consumed by an incandescent light bulb is emitted as heat rather than as visible light. In contrast, commercially available LEDs can exhibit efficiencies as high as 35%. However, LEDs must be powered with direct current. Therefore, an LED lighting device requires additional circuitry to transform the alternating current provided by a local power utility station, power generator, etc., to direct current, if the LED is not to be powered by a battery, fuel cell or other direct current producing electrical device. This limitation has been one of the principal factors for the delay in replacing relatively inefficient incandescent light bulbs with efficient LEDs in residential and industrial settings. Therefore, there is a need for an LED lighting device that can be placed within an incandescent light bulb socket and use the alternating current provided to the socket to power the LED.

### SUMMARY OF THE INVENTION

A light emitting diode (LED) lighting device for use in and powered through an incandescent light bulb alternating current socket is provided. The lighting device includes an LED light, a regulation circuit and a base. The regulation circuit converts an alternating current input to a direct current output useable by an LED. The base is adapted to fit within an incandescent light bulb alternating current socket. In addition to the LED light, regulation circuit and base, the invention preferably includes a heat sink that removes heat from the LED light, regulation circuit and combinations thereof. Even more preferably the heat sink is a ceramic. In addition, the regulation circuit can be a printed circuit that is printed directly onto the ceramic heat sink. The LED light, regulation circuit, base, and ceramic heat sink take the form of a lighting device that is exchangeable with an incandescent light bulb in traditional lighting fixtures powered by alternating current.

### BRIEF DESCRIPTION OF THE DRAWINGS

FIG. 1 shows a perspective view of a first embodiment of the present invention;

FIG. 2 shows an exploded view of FIG. 1;

FIG. 3 shows a schematic diagram of regulation circuit for an embodiment of the present invention;

FIG. 4 shows a ceramic heat sink for an embodiment of the present invention;

FIG. 5 shows a ceramic heat sink for a different embodiment of the present invention;

FIG. 6 shows a double-contact bayonet cap base for an embodiment of the present invention; and

FIG. 7 shows a double-pin base for an embodiment of the present invention.

### DETAILED DESCRIPTION OF THE INVENTION

The present invention comprises a simple to install, energy efficient light emitting diode (LED) lighting device that is interchangeable with traditional incandescent light bulbs. As such, the present invention has utility as a lighting device anywhere that incandescent light bulbs are used.

The lighting device of the present invention is comprised of an LED, a regulation circuit and a base. In addition, it is preferable that the LED lighting device includes a ceramic heat sink. The base is adapted to fit within and attach to a traditional incandescent light bulb socket. The regulation circuit transforms the alternating current provided to the light bulb socket to a direct current usable by the LED. The ceramic beat sink removes heat from the LED and/or regulation circuit and preferably provides a body for the attachment of the other components.

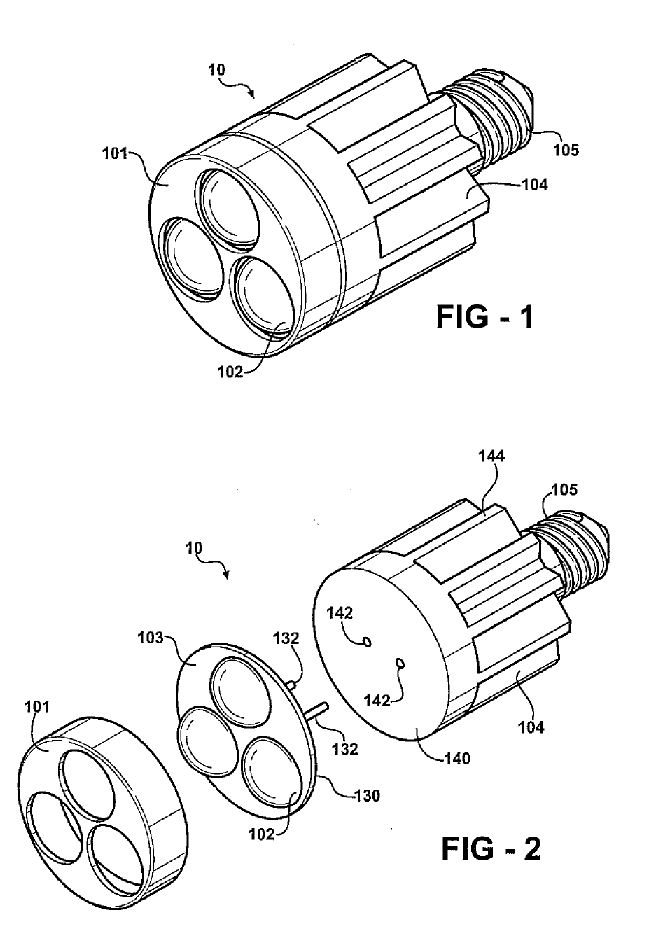

Referring now to FIGS. 1 and 2, there is shown one embodiment of an LED lighting device at reference numeral 10. The LED lighting device 10 of FIG. 1 includes a lens cap 101, at least one LED 102, a heat sink 104 and a base 105. Although not required for the present invention to be operable, the lens cap 101 affords support and secure positioning of the at least one LED 102. The lens cap 101 is made from any material known to those skilled in the art, illustratively including polymers, metals, ceramics, glass and combinations thereof. In addition, the lens cap 101 can attach to the heat sink 104 using a variety of attachment means, illustratively including threads so as to screw onto the heat sink 104, a snap fit, clips and combinations thereof.

The LED 102 can be any commercially available or noncommercially available LED, illustratively including LEDs manufactured from aluminum gallium arsenide, aluminum gallium phosphide, aluminum gallium indium phosphide, gallium arsenide phosphide, gallium phosphide, gallium nitride, indium gallium nitride, silicon carbide, silicon, sapphire, zinc selenide, diamond, aluminum nitride, aluminum gallium nitride and combinations thereof Although three LEDs 102 are illustrated in FIG. 1, any number of LEDs can be used in the present invention. In addition, each of the LEDs 102 can be of a different color, i.e. each LED 102 can produce a different color light and/or be a red-green-blue (RGB) 3 in 1 LED. Other color combination LEDs are also included in the present invention.

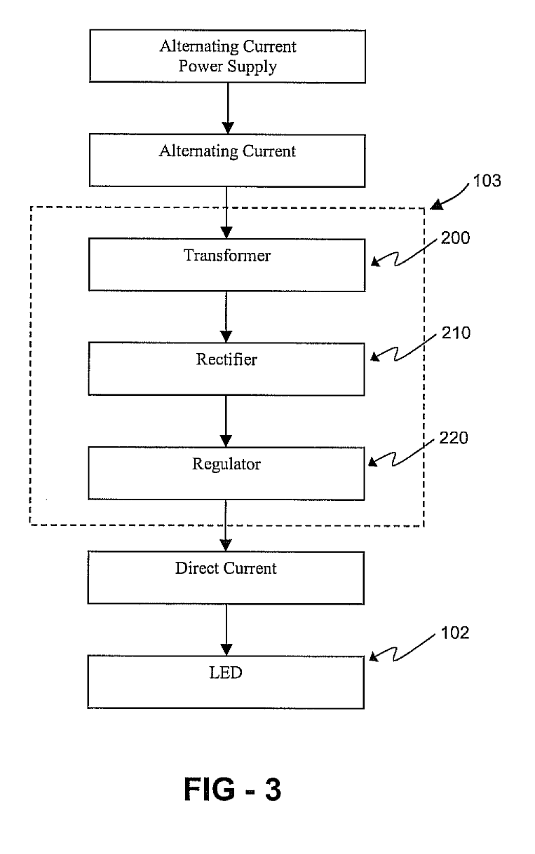

The LED lighting device includes a regulation circuit 103, preferably a printed circuit on a backing material. As shown in FIG. 3, the regulation circuit 103 affords for the transformation of an alternating current used to power a traditional incandescent light bulb to a direct current useable by the LED 102. For example, the regulation circuit 103 can transform a 110-120 volt alternating current used in North America and Japan to a 20 milliamp 2.2-2.6 volt direct current used by a red LED. Likewise, the regulating circuit 103 can transform a 110-120 volt or 220-240 volt alternating current to a 20 milliamp 3.5-4.0 volt direct current used by a green and/or blue LED.

The regulating circuit 103 can include any electronic device or component known to those skilled in the art to transform the alternating current input to the direct current output, illustratively including a transformer 200, a rectifier 210, and a regulator 220. Although not required for the present invention to be operable, the regulating circuit 103 can include a printed circuit on an appropriate backing, for example a circuit board 130. The circuit board 130 can include a pin 132, said pin affording for the accurate placement of the circuit board 130 onto the heat sink 104 by insertion into aperture 142, and/or electrical connection between the regulating circuit 103 and the base 105. In the alternative, the regulating circuit 103 can be a printed circuit printed directly onto the heat sink 104, illustratively including printing the circuit onto surface 140 of heat sink 104.

The heat sink 104 is preferably manufactured from a ceramic, illustratively including steatite, . . . (need more info on ceramics that can be used). A preferable ceramic material affords for the efficient removal of heat away from the LED 102 and/or regulating circuit 103. In addition, the ceramic heat sink 104 possesses the appropriate dielectric properties such that the heat sink is an electrical insulator. The heat sink 104 affords for the lens cap 101, LED 102, regulating circuit 103 and/or base 105 to be attached thereto,

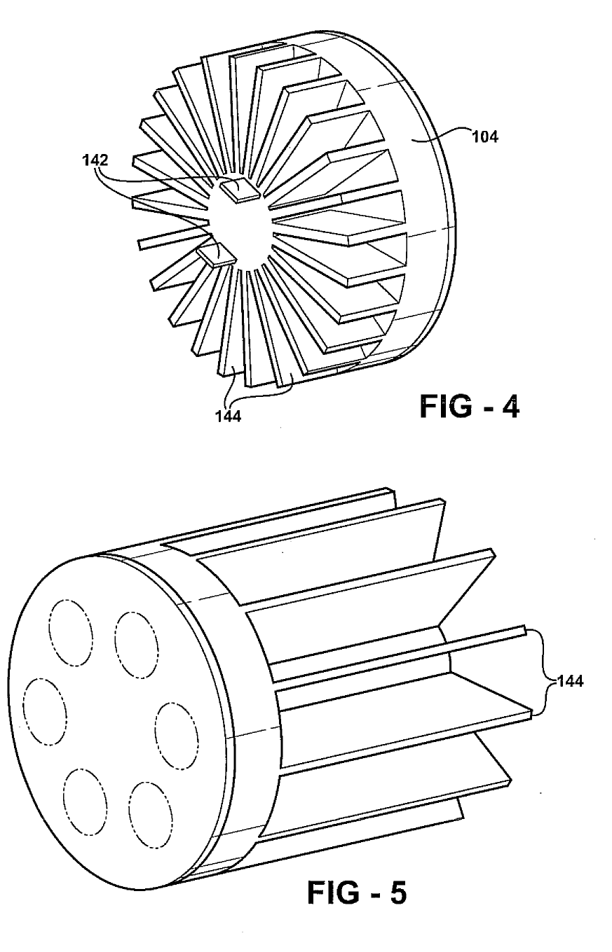

Turning to FIGS. 4 and 5, it is apparent that a plurality of designs, shapes and configurations can be used and still fall within the scope of the present invention. For example, FIG. 4 illustrates a tab 142. The tab 142 can afford an electrical connection between the base 105 and the regulation circuit 103 or simply aid in attaching the base 104 to the heat sink 104. FIG. 5 illustrates flexibility in the number and length of cooling fins 144, although the cooling fins 144 are not required for the present invention to be operable. And referring back to FIG. 2, the heat sink 104 can include apertures 142 which afford for attachment of the circuit board 130 thereto and/or electrical connection between the printed circuit 103 and base 105.

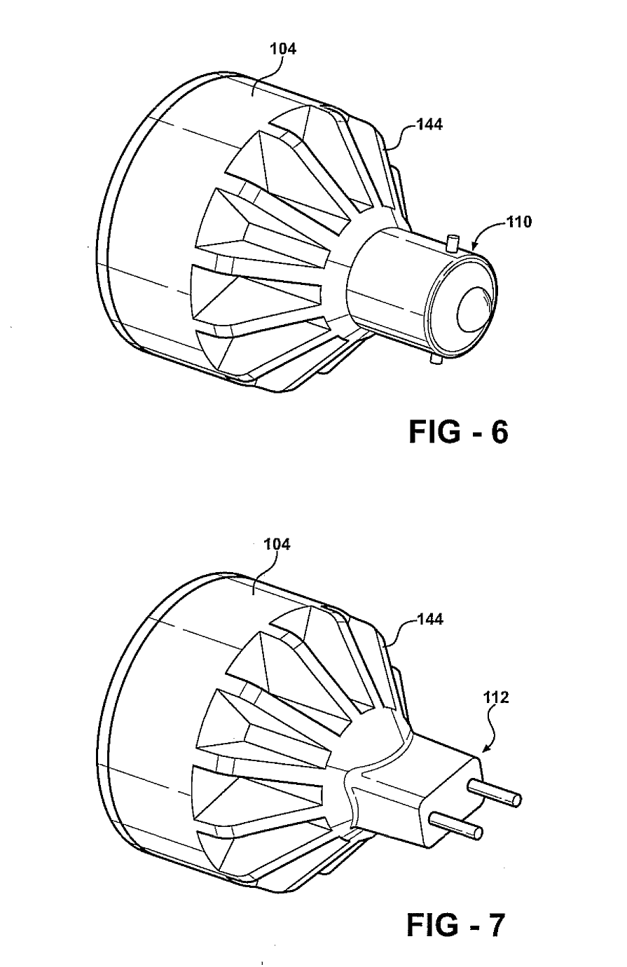

The base 105 as illustrated in FIGS. 1 and 2 is a screw base that affords for the screwing of LED lighting device 10 into a threaded light bulb socket. The screw base 105 can be adapted to fit within any threaded socket, illustratively including Edison screw 5 (E5), E10, E11, E12, E14, E17, E26, E27, E29, E39 and E40. In addition, the base can include a double-contact bayonet cap base 110 as illustrated in FIG. 6. In the alternative, the base can include a simple two-prong contact base 112 as shown in FIG. 7.

The base 105 is used to afford an electrical connection between an incandescent light bulb socket (not shown) and the regulating circuit 103. The regulating circuit 103 is in electrical connection with the LED light 102. The electrical connection can be afforded by a variety of connections means, illustratively including wires, electrodes, metal contacts, printed circuits and combinations thereof. Upon placement of the LED lighting device 10 within an incandescent light bulb socket, electrical power can be transmitted from the socket to the base 105, from the base 105 to the regulating circuit 103, and from the regulating circuit 103 to the LED 102.

The invention also includes an LED lighting device 10 with interchangeable bases. The interchangeable bases afford for a particular LED 102 and regulating circuit 103 to be used in more than one size of incandescent light bulb socket by simply removing a first base having one size and replacing the first base with a second base having a different size. In the alternative, the base 105 and the regulating circuit 103 can be interchangeable for the same purpose.

As described above in greater detail, the regulating circuit 103 transforms the alternating current supplied to the incandescent light bulb socket to a direct current usable by the LED 102. After the transformation of the alternating current to the direct current, said direct current is supplied to the LED 102. Supplying the direct current to the LED 102 results in an electrical bias in the forward direction of the semiconductor chip LED 102. With the regulating circuit 103 ensuring the appropriate current and voltage to a given LED 102, electrons and electron holes flow into the p-n junction of the semiconductor material, wherein electrons that meet with electron holes fall into a lower energy level and release energy in the form of photons. In this manner, an LED lighting device 10 useable in any incandescent light bulb fixture is provided.

The foregoing drawings, discussion and description are illustrative of specific embodiments of the present invention, but are not meant to be limitations upon the practice thereof. Numerous modifications and variations of the invention will be readily apparent to those of skill in the art in view of the teaching presented herein. It is the following claims, including all equivalents, which define the scope of the invention.

1. An LED lighting device for use in an incandescent light bulb socket powered by alternating current comprising:
an LED light;
a regulation circuit, said regulation circuit converting an alternating current input to a direct current output; and
a base, said base adapted to fit within an incandescent light bulb socket, for the purpose of providing an LED lighting device for use in an incandescent light bulb socket powered by alternating current.

2. The invention of claim 1, further comprising a heat sink, said heat sink providing removal of heat from an article selected from the group consisting of said LED light, said regulation circuit and combinations thereof.

3. The invention of claim 1, wherein said regulation circuit includes a transformer, a rectifier and a regulator.

4. The invention of claim 2, wherein said heat sink is a ceramic.

5. The invention of claim 1, wherein said regulation circuit is fixedly attached to said heat sink.

6. The invention of claim 5, wherein said regulation circuit is a printed circuit, said printed circuit printed onto said heat sink.

7. The invention of claim 6, wherein said regulation circuit is located between said LED light and said heat sink.

8. The invention of claim 4, wherein said LED light is fixedly attached to said ceramic heat sink.

9. The invention of claim 8, wherein said regulation circuit is fixedly attached to said ceramic heat sink.

10. The invention of claim 9, wherein said base is fixedly attached to said ceramic heat sink.

11. The invention of claim 4, wherein said ceramic heat sink is the body of an LED lighting device.

12. The invention of claim 1, wherein said base is in the form of a screw base, said screw base adapted to screw in and attach to an incandescent light bulb threaded socket.

13. The invention of claim 1, wherein said base is in the form of a double-contact bayonet cap, said double-contact bayonet cap adapted to be placed within and attached to an incandescent light bulb double-contact bayonet socket.

14. An LED lighting device for use in an incandescent light bulb socket powered by alternating current comprising:
at least one LED light;
a regulation circuit, said regulation circuit including a voltage transformer, a current rectifier and a voltage regulator for converting an alternating current input to a direct current output;
a ceramic heat sink, said heat sink providing removal of heat from an article selected from the group consisting of said LED light, said regulation circuit and combinations thereof, and
a base, said base adapted to fit within an incandescent light bulb socket and provide an electrical connection with the socket;
said base electrically connected to said regulation circuit and said regulation circuit electrically connected to said LED light, for the purpose of providing an LED lighting device for use in an incandescent light bulb socket powered by alternating current
